(19) United States
(12) Patent Application Publication
(10) Pub. No.: US 2024/0319072 A1
(43) Pub. Date: Sep. 26, 2024

(54) DETECTION SYSTEMS AND RELATED METHODS OF ANALYZING A FLUID

(71) Applicant: Saudi Arabian Oil Company, Dhahran (SA)

(72) Inventors: Nada Ibrahim Alruwaii, Thuwal (SA); Ali Alshehri, Thuwal (SA); Ahmed Aljarro, Thuwal (SA)

(21) Appl. No.: 18/186,572

(22) Filed: Mar. 20, 2023

(51) Int. Cl. G01N 21/01; B01L 3/00

(52) U.S. Cl. CPC G01N 21/01; B01L 3/502715; B01L 2300/0832; B01L 2300/0861; B01L 2400/0487; G01N 2021/0106

(57) ABSTRACT

A detection system includes a source of fluid and an optical channel in fluid communication with the source of fluid. The optical channel includes a wall structure, a microchannel extending axially through the wall structure to provide a flow path for the fluid, and a fluid inlet port and a fluid outlet port extending radially from the microchannel to an outer surface of the wall structure. The detection system further includes a laser source configured to emit laser light axially into the microchannel.

### TECHNICAL FIELD

This disclosure relates to detection systems that employ optofluidic techniques to detect the presence of diesel fuel within a hydrocarbon mixture.

### BACKGROUND

It is sometimes desirable to analyze fluids (e.g., hydrocarbons) to determine whether they contain (e.g., conceal or otherwise contain) diesel fuel. Diesel fuel chemical markers have thus been developed. The markers are added to a fluid suspected of containing diesel fuel, and the diesel fuel is identified when the fluid is then analyzed using chromatography or X-ray fluorescence spectrometers. This identification method requires large quantities of the marker and is therefore costly and impractical.

### SUMMARY

This disclosure relates to detection systems that employ optofluidic techniques to detect the presence of diesel fuel within a liquid hydrocarbon mixture.

In one aspect, a detection system includes a source of fluid and an optical channel in fluid communication with the source of fluid. The optical channel includes a wall structure, a microchannel extending axially through the wall structure to provide a flow path for the fluid, and a fluid inlet port and a fluid outlet port extending radially from the microchannel to an outer surface of the wall structure. The detection system further includes a laser source configured to emit laser light axially into the microchannel.

Embodiments may provide one or more of the following features.

In some embodiments, the microchannel is a first microchannel that is spaced apart from a central axis of the optical channel, and the optical channel further includes a second microchannel that extends axially along the central axis.

In some embodiments, the second microchannel includes a hollow optical core.

In some embodiments, the optical channel further includes multiple third microchannels that, together with the first microchannel, surrounds the second microchannel.

In some embodiments, an arrangement of the first microchannel and the multiple third microchannels is configured to prevent laser light within the second microchannel from escaping the second microchannel in a radial direction.

In some embodiments, the second microchannel and the multiple third microchannels are filled with air.

In some embodiments, the second microchannel and the multiple third microchannels do not contain any of the fluid.

In some embodiments, the first microchannel is spaced apart from the second microchannel and from the multiple third microchannels.

In some embodiments, the second microchannel has a cylindrical shape, and the first microchannel and the multiple third microchannels are arranged around a circumference of the second microchannel.

In some embodiments, the first microchannel and each of the multiple third microchannels has a cylindrical shape.

In some embodiments, the first microchannel and each of the multiple third microchannels has a substantially polygonal shape.

In some embodiments, a first width of the first microchannel is less than a second width of the second microchannel.

In some embodiments, the inlet port is spaced apart from the first end of the optical channel by a distance of about 100 mm to about 1,000 mm, and the outlet port is spaced apart from the second end of the optical channel by a distance of about 100 mm to about 1,000 mm.

In some embodiments, the detection system further includes a pump configured to pump the fluid through the microchannel.

In some embodiments, the laser source is configured to emit the laser light into a first end of the microchannel, and the detection system further includes a spectrometer configured to collect at least a portion of the laser light from the microchannel at a second end of the microchannel.

In some embodiments, detection system further includes a computing system that is configured to generate a transmitted light spectrum from the portion of the laser light collected in the spectrometer.

In some embodiments, the transmitted light spectrum is a target transmitted light spectrum, and the computing system is further configured to compare the target transmitted light spectrum to a reference transmitted light spectrum and determine the presence or absence of a chemical substance within the fluid based on a comparison between the target and reference transmitted light spectrums.

In some embodiments, the fluid is a liquid hydrocarbon mixture.

In some embodiments, the detection system is configured to detect the presence of diesel fuel within the liquid hydrocarbon mixture.

In another aspect, a method of analyzing a fluid using a detection system includes flowing the fluid into a microchannel of an optical channel, the optical channel including a wall structure, the microchannel, extending axially through the wall structure to provide a flow path for the fluid, and a fluid inlet port and a fluid outlet port extending radially from the microchannel to an outer surface of the wall structure. The method further includes emitting laser light axially into the microchannel from a laser source.

The details of one or more embodiments are set forth in the accompanying drawings and description. Other features, aspects, and advantages of the embodiments will become apparent from the description, drawings, and claims.

### DESCRIPTION OF DRAWINGS

FIG. 1 is a schematic view of an example detection system.

FIG. 2 is a perspective view of an example optical channel of the detection system of FIG. 1.

FIG. 3 is a front view of the optical channel of FIG. 2.

FIG. 4 is a graph of a reference transmitted light spectrum and a target transmitted light spectrum.

FIG. 5 is a front view of an example optical channel.

FIG. 6 is a front view of an example optical channel.

FIG. 7 is a front view of an example optical channel.

FIG. 8 is a flow chart illustrating an example method of analyzing a fluid utilizing the detection system of FIG. 1.

### DETAILED DESCRIPTION

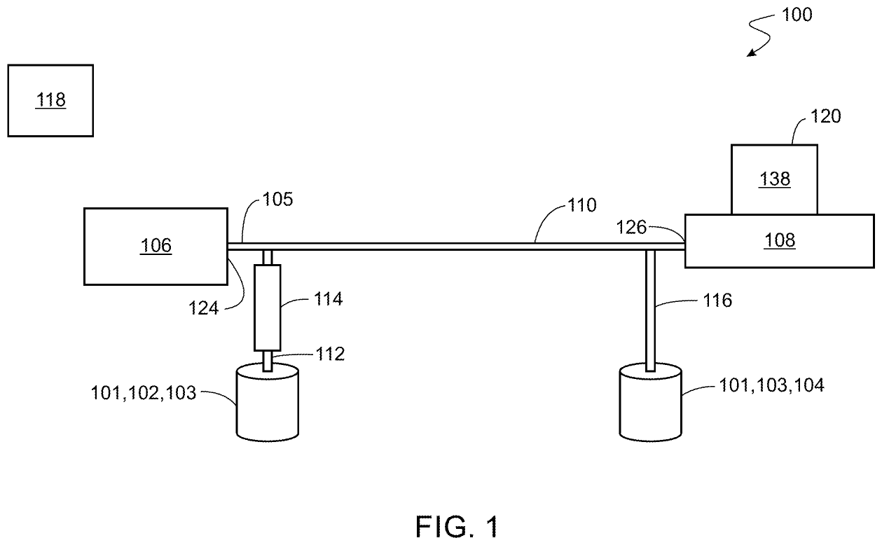

FIG. 1 illustrates an example detection system 100 for detecting the presence of a chemical substance within a fluid (e.g., a fluid analyte). The detection system 100 is designed to identify the chemical substance based on a transmission of light through the fluid as the fluid flows through the detection system 100. In the example of FIG. 1, the chemical substance is diesel fuel 101, and the fluid is a liquid hydrocarbon mixture 103 (e.g., a liquid mixture of two or more hydrocarbons).

The detection system 100 includes an inlet container 102 that stores the hydrocarbon mixture 103, an optical channel 110 that receives an input flow of the hydrocarbon mixture 103 from the inlet container 102, an outlet container 104 that receives a discharge flow of the hydrocarbon mixture 103 from the optical channel 110, a laser source 106 that emits laser light 105 into the optical channel 110, and a spectrometer 108 that receives the portion of the laser light 105 that has been transmitted through the optical channel 110. In some embodiments, the laser source 106 is a femtosecond Ti:sapphire laser or a neodymium:yttrium-aluminum-garnet (Nd:YAG) laser.

The detection system 100 also includes an inlet conduit 112 that extends between the inlet container 102 and the optical channel 110, a pump 114 positioned along the inlet conduit 112 for pumping the hydrocarbon mixture 103 from the inlet container 102 into the optical channel 110, and an outlet conduit 116 that extends between the optical channel 110 and the outlet container 104. In some embodiments, the pump 114 is a peristaltic pump or another type of roller pump.

The detection system 100 further includes a controller 118 for controlling one or more components (e.g., the laser source 106, the pump 114, and the spectrometer 108) of the detection system 100. The detection system 100 also includes a computing system 120 with one or more processors 138 by which data (e.g., corresponding to the transmitted laser light 105 collected by the spectrometer 108) can be analyzed to detect the presence of the diesel fuel 101 and to calculate or otherwise determine certain properties or characteristics of the diesel fuel 101. The controller 118 and the computing system 120 may be coupled to various other components of the detection system 100 via one or both of wired and wireless connections.

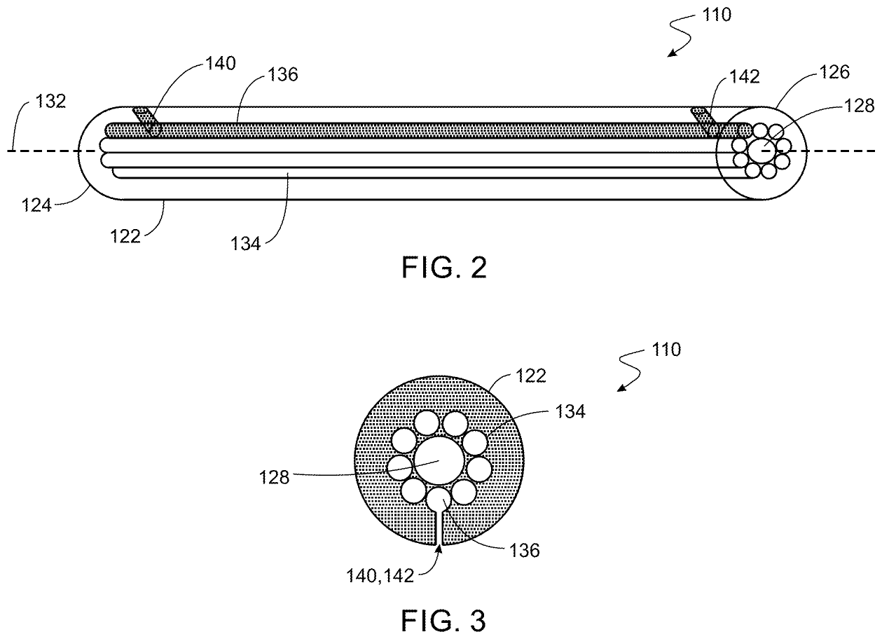

FIGS. 2 and 3 illustrate an example embodiment of the optical channel 110 (e.g., a microstructured optical fiber). The optical channel 110 extends between the laser source 106 at a first end 124 and the spectrometer 108 at a second end 126. The optical channel 110 is formed as a solid cylindrical wall structure 122 with multiple microchannels that extend through the wall structure 122. The microchannels include a central microchannel 128 (e.g., a hollow optical core) that is positioned (e.g., centered) along a central axis 132 of the optical channel 110 and multiple surrounding microchannels 134, 136 that are arranged around a circumference of the central microchannel 128. The microchannels 128, 134, 136 are closed at the first and second ends 124, 126 of the optical channel 110. While the example optical channel 110 of FIGS. 2 and 3 includes nine surrounding microchannels 134, 136, in some embodiments, an optical channel that is otherwise substantially similar in construction and function to the optical channel 110 may include a different number of surrounding microchannels.

Each microchannel 128, 134, 136 has a cylindrical shape that is defined by the wall structure 122 through which the microchannel 128, 134, 136 passes. The wall structure 122 forms a complete circumferential surface around each microchannel 128, 130, 136 such that the microchannels 128, 130, 136 are structurally and fluidically separate from each other (e.g., the microchannels 128, 130, 136 are not in fluid communication with each other). The surrounding microchannel 136 provides a flow path for the liquid hydrocarbon mixture 103 and is therefore designated as an optofluidic microchannel 136 that is fluidically connected to the inlet and outlet containers 102, 104. Accordingly, the wall structure 122 further defines an inlet port 140 and an outlet port 142 that extend radially (e.g., perpendicularly to the optofluidic microchannel 136 and to central axis 132) through the wall structure 122 between the optofluidic microchannel 136 and the inlet and outlet conduits 112, 116, respectively. The optofluidic microchannel 136 is otherwise identical in structure to the surrounding microchannels 134.

The inlet and outlet ports 140, 142 may have a cylindrical shape (e.g., as illustrated in FIG. 3) or a non-cylindrical shape. In some embodiments, the inlet and outlet ports 140, 142 have a diameter (e.g., or a width) of about 500 μm to about 1000 μm. In some embodiments, the inlet and outlet ports 140, 142 are respectively located about 100 mm to about 1000 mm from the first and second ends 124, 126 of the optical channel 110. Positioning of the ports 140, 142 apart from the first and second ends 124, 126 of the optical channel 110 advantageously avoids obstruction, disruption, and disturbance of the optical input (e.g., the emitted laser light 105) from the laser source 106 and advantageously avoids obstruction, disruption, and disturbance of the optical transmission (e.g., the transmitted laser light) to the spectrometer 108. Furthermore, such positioning of the ports 140, 142 within the wall structure 122 provides easy access to the containers 102, 104 and thus allows a relatively fast in-and-out diffusion (e.g., a relatively high flowrate of the hydrocarbon mixture 103) within the optofluidic microchannel 136.

The wall structure 122 of the optical channel 110 is made of one or more non-metallic, transparent or translucent materials, such as polymethyl methacrylate (PMMA) materials for a plastic optical fiber or silica materials for a glass optical fiber. In general, the smaller the detection system 100, the more accurate is the system and the less likely the system is to experience optical losses. In some embodiments, the optical channel 110 has a length of about 10 centimeters (cm) to about 20 cm. The central microchannel 128 is wider (e.g., larger) in a cross-sectional dimension (e.g., diameter) than the surrounding microchannels 134, 136. In some embodiments, such as in the example optical channel 110 of FIGS. 2 and 3, all of the surrounding microchannels 134, 136 have the same diameter and are spaced equidistantly around the circumference of the central microchannel 128. In some embodiments, the surrounding microchannels 134, 136 may be unequally spaced around the circumference of the central microchannel 128.

The optofluidic microchannel 136 provides a fluid flow path by which the liquid hydrocarbon mixture 103 flows from the inlet container 102 to the outlet container 104. Moreover, the laser source 106 is coupled to the optical channel 110 in such a way that the laser light 105 is directed from the laser source 106 into the optofluidic microchannel 136, but is not directed from the laser source 106 into the central microchannel 128 or into the other surrounding microchannels 134. A small portion of the laser light 105 that has been emitted into the optofluidic channel 136 transmits radially or otherwise laterally through the wall structure 122 from the optofluidic channel 136 into the microchannels 128, 134. Therefore, the microchannels 128, 134 contain air and a small amount of laser light 105, but do not contain any of the hydrocarbon mixture 103. Limiting emission of the laser light 105 from the laser source 106 to the optofluidic microchannel 136 advantageously results in concentrated and condensed interactions between the laser light 105 and the hydrocarbon mixture 103, which increases the sensitivity of the optical channel 110 to changes in refractive index of any hydrocarbon mixture 103 flowing through the optical channel 110.

The circumferential arrangement of the surrounding microchannels 134, 136 forms an optical layer (e.g., an optical cladding) that creates a photonic crystal microstructure. The crystal microstructure, surrounding the relatively large-diameter central microchannel 128, produces properties of the optical channel 110 that are unattainable for conventional optical fibers. For example, any laser light 105 that has passed into the central microchannel 128 through the wall structure 122 from the optofluidic channel 136 is in large part trapped within the central microchannel 128 by the crystal microstructure. Such light trapping advantageously minimizes transmission loss (e.g., the total amount of laser light 105 lost from the optical channel 110 to the ambient environment) and thus allows the hydrocarbon mixture 103 and any diesel fuel 101 contained therein to interact strongly with the laser light 105 as the laser light 105 is guided through the optical channel 110. In other words, the surrounding microchannels 134, 136 form a photonic bandgap that acts as a highly reflective mirror to minimize radial escape of laser light 105 from the central microchannel 128. The low-loss mode resulting from the surrounding microchannels 134, 136 provides improved waveguide properties (e.g., increased sensitivity and increased accuracy) of the detection system 100 as compared to detection systems with conventional optical fibers.

Referring to FIG. 1, in operation of the detection system 100, the liquid hydrocarbon mixture 103 should be prepared for testing. The hydrocarbon mixture 103 has a relatively low transparency (e.g., is relatively opaque) and has relatively high light-absorbing properties that would distort spectrometer readings. Therefore, prior to testing the hydrocarbon mixture 103 using the detection system 100, the hydrocarbon mixture 103 is diluted with water. With a sample of the hydrocarbon mixture 103 (e.g., diluted with water) deposited within the inlet container 102, the detection system 100 is operated to test the hydrocarbon mixture 103 for diesel fuel 101. In some embodiments, the detection system 100 can detect a diesel fuel concentration as low as about 0.05%.

The laser source 106 is activated to emit laser light 105 into the optofluidic microchannel 136 at the first end 124 of the optical channel 110, and the spectrometer 108 is activated to collect transmitted laser light 105 at the second end 126 of the optical channel 110. The pump 114 is then activated to pump the hydrocarbon mixture 103 from the inlet container 102 to the outlet container 104 through the inlet conduit 112, the optofluidic microchannel 136, and the outlet conduit 116. The laser source 106, spectrometer 108, and pump 114 are operated by the controller 118. In some examples, the wavelength of the emitted laser light 105 is varied by the laser source 106 within a range of about 500 nanometers (nm) and 1000 nm. In some examples, the hydrocarbon mixture 103 is pumped through the optofluidic microchannel 136 at a rate on the order of micrometers per second. In some examples, the residence time of the hydrocarbon mixture 103 within the optofluidic microchannel 136 is up to about 20 seconds (s).

As the hydrocarbon mixture 103 is pumped through the optofluidic microchannel 136, transmitted laser light 105 is collected in the spectrometer 108, with most of the transmitted laser light 105 coming from the optofluidic microchannel 136. In some embodiments, transmittance and reflection coefficients of laser propagation will be measured. In some examples, the hydrocarbon mixture 103 is pumped through the optofluidic microchannel 136 for a total time of about 15 minutes (min) per test to collect an optimal amount of transmitted laser light 105 in the spectrometer 108. The spectrometer 108 or the computing system 120 (e.g., coupled to the spectrometer 108) generates one or more transmitted light spectrums 146 from the transmitted laser light 105 and sends the transmitted light spectrums to a processing device (e.g., a viewing device or another type of processing device).

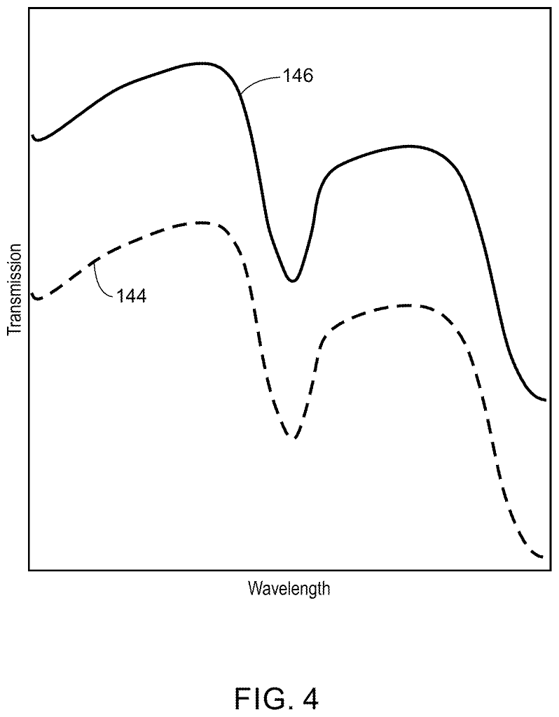

FIG. 4 is a graph showing an example transmitted light spectrum 144 for a reference hydrocarbon mixture (e.g., diluted with water) that does not contain diesel fuel and an example transmitted light spectrum 146 for a target hydrocarbon mixture (e.g., diluted with water) that contains diesel fuel at a particular concentration, such as the example hydrocarbon mixture 103 discussed above with respect to FIGS. 1-3. At the computing system 120, the detection system 100 can identify the presence of diesel fuel 101 within the hydrocarbon mixture 103 corresponding to the transmitted light spectrum 146 based on one or more of a difference between the maximums, a difference between the minimums, and a difference between the centroids of the transmitted light spectrums 144, 146. As shown in FIG. 4, the reference hydrocarbon mixture of the transmitted light spectrum 144 has an overall lower transmission than the target hydrocarbon mixture of the transmitted light spectrum 146. The computing system 120 can output an indication of the presence (e.g., or lack of presence, in other examples) of the diesel fuel 101 to a processing device for a user.

From the generated transmitted light spectrum 146, the computing system 120 can calculate the refractive index of the hydrocarbon mixture 103 that includes diesel fuel 101 and calculate the concentration of the diesel fuel 101 within the hydrocarbon mixture 103 from the refractive index. For example, as the concentration of diesel fuel increases, the maximum and minimum of a transmitted light spectrum change, and the refractive index increases. By repetitively and continuously testing samples of hydrocarbon mixtures 103 with varied concentrations of diesel fuel 101 over varied wavelengths of the emitted laser light 105, several corresponding refractive indexes can be calculated and plotted as a function of wavelength to produce an optical dispersion curve for a liquid hydrocarbon mixture containing diesel fuel. After testing has been completed, the optofluidic microchannel 136 is cleaned with a water flow to remove any remaining solutions and molecules to ensure the accuracy of results obtained during subsequent tests.

The detection system 100 provides for several advantages relative to conventional systems. For example, the detection system 100 allows for fast, real-time detection of diesel fuel within a hydrocarbon mixture with accurate and detailed results in a cost-effective manner. Additionally, the detection system 100 is designed to detect diesel fuel without adding any chemical fuel markers to the hydrocarbon mixture, such that associated time, costs, and transport of the hydrocarbon mixture to a laboratory for marker analysis with chromatography or X-ray fluorescence spectrometers is avoided. Accordingly, the detection system 100 is an integrated, comprehensive system that allows all steps of the testing protocol to be performed sequentially at one location. The spectrometer 108 can be installed in, assembled with, or otherwise coupled to the computing system 120 for output of easy-to-read results. Furthermore, the detection system 100 allows for not only detection of the presence of diesel fuel, but determination of its concentration within a liquid hydrocarbon mixture. The detection system 100 also requires little maintenance, can be operated with little training, and is easily and immediately accessible by appropriate authorities to perform an intervention (e.g., a testing protocol to detect the presence of diesel fuel within a suspect liquid hydrocarbon mixture).

Other embodiments are also possible. For example, in some embodiments, a detection system 200, 300, 400 that is otherwise substantially similar in construction and function to the detection system 100 includes an optical channel 210, 310, 400, respectively, that enables a different light-matter interaction between the laser light 105 and the liquid hydrocarbon mixture 103 and wall structure). Accordingly, each of the detection systems 200, 300, 400 also includes the inlet container 102, the outlet container 104, the laser source 106, the spectrometer 108, the inlet conduit 112, the pump 114, the outlet conduit 116, the controller 118, and the computing system 120.

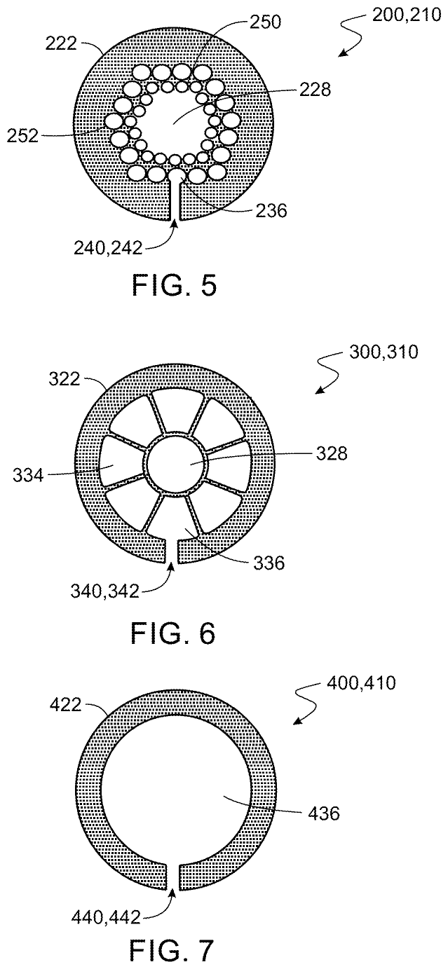

FIG. 5 illustrates the optical channel 210 of the detection system 200. The optical channel 210 is similar in construction and function to the optical channel 110 of the detection system 100, except that it includes a different configuration of microchannels. The optical channel 210 is formed as a wall structure 222 (e.g., an optical fiber) with multiple cylindrical microchannels that extend through the wall structure 222. The microchannels include a set of first microchannels 250 that are arranged to form a central microchannel 228 along a central axis of the optical channel 210 and a set of second microchannels 252 arranged around the first microchannels 250. Each set of microchannels 250, 252 is arranged to form a substantially polygonal (e.g., hexagonal) shape in a cross-sectional dimension of the optical channel 210. Accordingly, the central microchannel 228 also has a substantially polygonal cross-sectional shape. A selected optofluidic microchannel 236 of the microchannels 252 is fluidically connected to the inlet and outlet containers 102, 104. Accordingly, an inlet port 240 and an outlet port 242 extend radially through the wall structure 222 from the optofluidic microchannel 236 to the inlet and outlet conduits 112, 116, respectively.

FIG. 6 illustrates the optical channel 310 of the detection system 300. The optical channel 310 is similar in construction and function to the optical channel 110 of the detection system 100, except that it includes a different configuration of microchannels. Accordingly, the optical channel 310 is formed as a wall structure 322 (e.g., an optical fiber) with multiple microchannels that extend through the wall structure 322. The microchannels include a central microchannel 328 (e.g., a cylindrical microchannel) that is positioned (e.g., centered) along a central axis of the optical channel 310 and multiple (e.g., eight or a different number of) surrounding microchannels 334 that are arranged around a circumference of the central microchannel 328. The surrounding microchannels 334 are substantially polygonal-shaped. A selected optofluidic microchannel 336 of the microchannels 334 is fluidically connected to the inlet and outlet containers 102, 104. Accordingly, an inlet port 340 and an outlet port 342 extend radially through the wall structure 322 from the optofluidic microchannel 336 to the inlet and outlet conduits 112, 116, respectively.

FIG. 7 illustrates the optical channel 410 of the detection system 400. The optical channel 410 is similar in construction and function to the optical channel 110 of the detection system 100, except that it includes only a single, cylindrical microchannel 436 formed by a channel wall 422 (e.g., an optical fiber). Compared to the optical channels 110, 210, 310, the optical channel 410, owing to the single-channel design, can allow passage of a larger volume of hydrocarbon mixture 103.

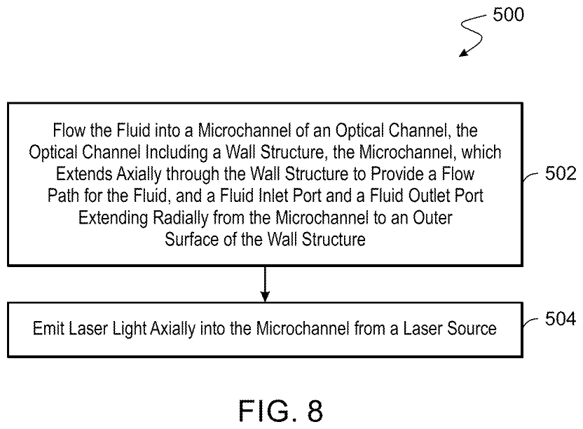

FIG. 8 is a flow chart illustrating an example method 500 of analyzing a fluid (e.g., the hydrocarbon mixture 103). In some embodiments, the method 500 includes a step 502 for flowing the fluid into a microchannel (e.g., the optofluidic microchannel 136, 236, 336, 436) of an optical channel (e.g., the optical channel 110, 210, 310, 410), the optical channel including a wall structure (e.g., the wall structure 122, 222, 322, 422), the microchannel, extending axially through the wall structure to provide a flow path for the fluid, and a fluid inlet port (e.g., the inlet port 140) and a fluid outlet port (e.g., the outlet port 142) extending radially from the microchannel to an outer surface of the wall structure. In some embodiments, the method 500 further includes a step 504 for emitting laser light (e.g., the laser light 105) axially into the microchannel from a laser source (e.g., the laser source 106).

While the detection systems 100, 200, 300, 400 and the optical channels 110, 210, 310, 410 have been described and illustrated with respect to certain dimensions, sizes, shapes, arrangements, materials, and methods, in some embodiments, a detection system or optical channel that is otherwise substantially similar in construction and function to the detection system 100, 200, 300, 400 or to the optical channel 110, 210, 310, 410 may include one or more different dimensions, sizes, shapes, arrangements, configurations, and materials or may be utilized according to different methods. Accordingly, other embodiments are also within the scope of the following claims.

What is claimed is:

1. A detection system comprising:
a source of fluid;
an optical channel in fluid communication with the source of fluid, the optical channel comprising:
a wall structure,
a microchannel extending axially through the wall structure to provide a flow path for the fluid, and
a fluid inlet port and a fluid outlet port extending radially from the microchannel to an outer surface of the wall structure; and
a laser source configured to emit laser light axially into the microchannel.

2. The detection system of claim 1, wherein the microchannel is a first microchannel that is spaced apart from a central axis of the optical channel, and wherein the optical channel further comprises a second microchannel that extends axially along the central axis.

3. The detection system of claim 2, wherein the second microchannel comprises a hollow optical core.

4. The detection system of claim 2, wherein the optical channel further comprises a plurality of third microchannels that, together with the first microchannel, surrounds the second microchannel.

5. The detection system of claim 4, wherein an arrangement of the first microchannel and the plurality of third microchannels is configured to prevent laser light within the second microchannel from escaping the second microchannel in a radial direction.

6. The detection system of claim 4, wherein the second microchannel and the plurality of third microchannels are filled with air.

7. The detection system of claim 4, wherein the second microchannel and the plurality of third microchannels do not contain any of the fluid.

8. The detection system of claim 4, wherein the first microchannel is spaced apart from the second microchannel and from the plurality of third microchannels.

9. The detection system of claim 4, wherein the second microchannel has a cylindrical shape, and wherein the first microchannel and the plurality of third microchannels are arranged around a circumference of the second microchannel.

10. The detection system of claim 4, wherein the first microchannel and each of the plurality of third microchannels has a cylindrical shape.

11. The detection system of claim 4, wherein the first microchannel and each of the plurality of third microchannels has a substantially polygonal shape.

12. The detection system of claim 4, wherein a first width of the first microchannel is less than a second width of the second microchannel.

13. The detection system of claim 1, wherein the inlet port is spaced apart from the first end of the optical channel by a distance of about 100 mm to about 1,000 mm, and wherein the outlet port is spaced apart from the second end of the optical channel by a distance of about 100 mm to about 1,000 mm.

14. The detection system of claim 1, further comprising a pump configured to pump the fluid through the microchannel.

15. The detection system of claim 1, wherein the laser source is configured to emit the laser light into a first end of the microchannel, and wherein the detection system further comprises a spectrometer configured to collect at least a portion of the laser light from the microchannel at a second end of the microchannel.

16. The detection system of claim 15, further comprising a computing system that is configured to generate a transmitted light spectrum from the portion of the laser light collected in the spectrometer.

17. The detection system of claim 16, wherein the transmitted light spectrum is a target transmitted light spectrum, and wherein the computing system is further configured to:
compare the target transmitted light spectrum to a reference transmitted light spectrum; and
determine the presence or absence of a chemical substance within the fluid based on a comparison between the target and reference transmitted light spectrums.

18. The detection system of claim 1, wherein the fluid comprises a liquid hydrocarbon mixture.

19. The detection system of claim 18, wherein the detection system is configured to detect the presence of diesel fuel within the liquid hydrocarbon mixture.

20. A method of analyzing a fluid using a detection system, the method comprising:
flowing the fluid into a microchannel of an optical channel, the optical channel comprising:
a wall structure,
the microchannel, extending axially through the wall structure to provide a flow path for the fluid, and
a fluid inlet port and a fluid outlet port extending radially from the microchannel to an outer surface of the wall structure; and
emitting laser light axially into the microchannel from a laser source.
